(19) United States
(12) Patent Application Publication
(10) Pub. No.: US 2024/0410860 A1
(43) Pub. Date: Dec. 12, 2024

(54) BURIED PIPE ASSESSMENTS (CONDITION ASSESSMENT AND MATERIAL IDENTIFICATION) BASED ON STRESS WAVE PROPAGATION

(71) Applicant: Drexel University, Philadelphia, PA (US)

(72) Inventors: Ivan Bartoli, Ardmore, PA (US); Charles Nathan Haas, Philadelphia, PA (US); Kurt Sjoblom, Boxborough, MA (US)

(73) Assignee: Drexel University, Philadelphia, PA (US)

(21) Appl. No.: 18/695,147

(22) PCT Filed: Sep. 28, 2022
(86) PCT No.: PCT/US22/77174

§ 371 Date: Mar. 25, 2024

Related U.S. Application Data
(60) Provisional application No. 63/251,852, filed on Oct. 4, 2021.

(51) Int. Cl. G01N 29/11; G01N 29/07

(52) U.S. Cl. CPC G01N 29/11; G01N 29/07

(57) ABSTRACT

A nondestructive evaluation method for determining the material used in a below-ground service line includes inserting a probe with a wave measurement device therein into an area corresponding to a location of a service line; generating a service line wave through an exposed portion of the service line using a vibratory shaker or other mechanical excitation; measuring, by the wave measurement device, a substrate wave created by the service line wave passing thought the service line and into the substrate; identifying, by a data acquisition system, the service line wave velocity and attenuation; comparing the service line wave velocity and attenuation to a known set of wave velocities and attenuations in service lines according to a service line material; and identifying the service line material in the service line by comparing the wave velocity and attenuation in the service line with the known set of wave velocities and attenuations.

### BACKGROUND

In 1991, the US EPA published the ‘Lead and Copper Rule’ (LCR) regulation to address the widespread legacy use of lead pipes for potable water delivery and service lines. While well-intended, the regulation received immediate push-back from municipal water utility companies that cited compliance with the regulation was too difficult to implement in the LCR's time-line and owner-utility responsibility was ill-defined. As a result, the American Water Works Association (AWWA) sued the EPA in 1993 and a Federal Appeals Court partially sided with the AWWA. After several years of back and forth, the LCR was amended in 2000 to allow for utility companies to perform ‘partial replacements of water delivery lines. This made the problem worse, as it allowed for the utility companies to replace main water lines, but leave the lead service lines intact and the responsibility of the landowner to complete the replacement. This has left many homeowners unsure or falsely sure of whether their service lines are made of lead.

This issue has come to the forefront of the Nation's attention due to the recent problems found in Flint, Michigan. Flint is not alone in their plight in dealing with this issue, nearly all urban areas have used and continue to have lead service and distribution lines. This problem is particularly worse in older and larger cities including Washington, DC, Boston and Philadelphia due to scarce records of the original pipe installations.

Considering this history, there is a current need to rapidly and cost effectively identify the service line material supplying water to homeowners and residents in urban areas. Since visual line inspection or water sampling are the current methods for line material testing—the former is time and effort consuming, and the latter is costly and unreliable.

Common nondestructive evaluation (NDE) methods detect, locate, and identify the material of buried pipelines. Closed-circuit television, originally introduced in the 1960s for the detection of leaks in pipes and sewers, is a slow process and may require a pipe to be drained before inspection, resulting in high operative costs. Recent state-of-the-art electromagnetic induction metal detectors can detect small metal objects at shallow depths and large metal objects at greater depths under a wide range of environmental and soil conditions. A technique based on eddy currents, the remote field eddy current technique, has been also developed for the inspection of both ferromagnetic and nonferromagnetic conducting tubular from the inside. Ground penetrating radar (GPR) is an established technology that uses electromagnetic waves to identify buried objects by detecting their reflections.

Although different algorithms that use GPR data have been successfully developed for detection and geometric characterization purposes (including the effect of fluid interface), the material characterization of the buried pipe remains a challenging task. Moreover, the depth of penetration is greatly reduced in the presence of conductive soils such as clay and saturated soils, which induce high signal attenuation. The broadband electromagnetics/wave impedance probe technique is a hybrid of GPR and electromagnetic techniques, able to detect differences in the electromagnetic impedance of the material being tested. Although the system is suited for pipelines of a relatively small diameter (˜200 mm) and shallow surveys at the 0.5 to 10 m scale, it is not useful for ferrous pipes. Thermal/infrared testing (IR) relies on the use of an infrared scanner that is sensitive to short- or medium-wave infrared radiation to measure variations in temperature produced by the effect of the pipeline, which in turn are converted into thermographic images in which objects are represented by their thermal rather than their optical values. However, as with the GPR, the location using IR is affected by the properties of the surrounding ground, in particular moisture content. Similarly, ground cover and wind speed have been known to influence results. The greatest drawback, however, is its inability to measure depth.

While these methods and techniques provide some vision of buried infrastructure, none are intended to characterize the material of a water service pipeline quickly and accurately. On the other hand, guided ultrasonic waves have been used as a highly efficient method for the NDE and structural health monitoring of slender solids with finite dimensions such as pipelines, railroads, aerospace panels, and in several other research applications. Compared to ultrasonic bulk waves, guided waves provide larger monitoring ranges and complete coverage of the component (waveguide) cross section. Compared to global (lower frequency) vibrations, guided waves provide increased sensitivity to smaller defects due to the larger frequencies. Guided waves are stress waves that cover a broad frequency range from as low as hundreds of Hz to MHz depending on the component tested. These advantages can be fully exploited only once the complexities of guided wave propagation are fully understood and managed for the given test structure. Despite the many uses of guided waves to assess pipelines, to the best of the inventors’ knowledge no attempt has been made to assess the material of buried water pipelines and discover the presence of lead, a challenge exacerbated by the fact that lead and plastic often appear similar to traditional detection methods.

### SUMMARY OF THE EMBODIMENTS

A nondestructive evaluation method for determining the material used in a below ground service line includes inserting a probe with a wave measurement device therein into an area corresponding to a location of a service line; generating a service line wave through an exposed portion of the service using a vibratory shaker or another source of mechanical energy (such as instrumented testing hammer); measuring, by the wave measurement device, a substrate wave created by the service line wave passing thought the service line and into the substrate; identifying, by a data acquisition system, the service line wave velocity and attenuation; comparing the service line wave velocity and attenuation to a known set of wave velocities and attenuations in service line according to a service line material; and identifying the service line material in the service line by comparing the wave velocity and attenuation in the service line with the known set of wave velocities and attenuations.

### BRIEF DESCRIPTION OF THE DRAWINGS

FIG. 1 shows Wave Velocity vs Wave Attenuation (energy loss per distance travelled) for pipes of different materials.

FIG. 2 shows a representation of typical field test.

FIG. 3 shows waves signals recorded by two accelerometers A1 and A2 placed as in FIG. 2; time delay Dt used to estimate wave speed; amplitude ratio A1/A2 is used to compute wave attenuation.

FIG. 4 shows wave velocity of guided waves travelling along a pipe: L (0,1) is the fundamental longitudinal mode which is almost non dispersive in the 0-10 kHz frequency range; the fundamental flexural mode F (1,1) is dispersive (speed changes with frequency) and the fundamental torsional mode is non dispersive. The properties shown are for a steel pipe with 0.025 m outer radius and 0.003175 m thickness.

### DETAILED DESCRIPTION OF THE EMBODIMENTS

Certain techniques of pipe material identification have been previously described in U.S. Pat. No. 10,145,820, the entirety of which is incorporated by reference as if fully set forth herein.

The invention seeks to identify lead-based water pipes using stress acoustic waves (for instance guided waves).

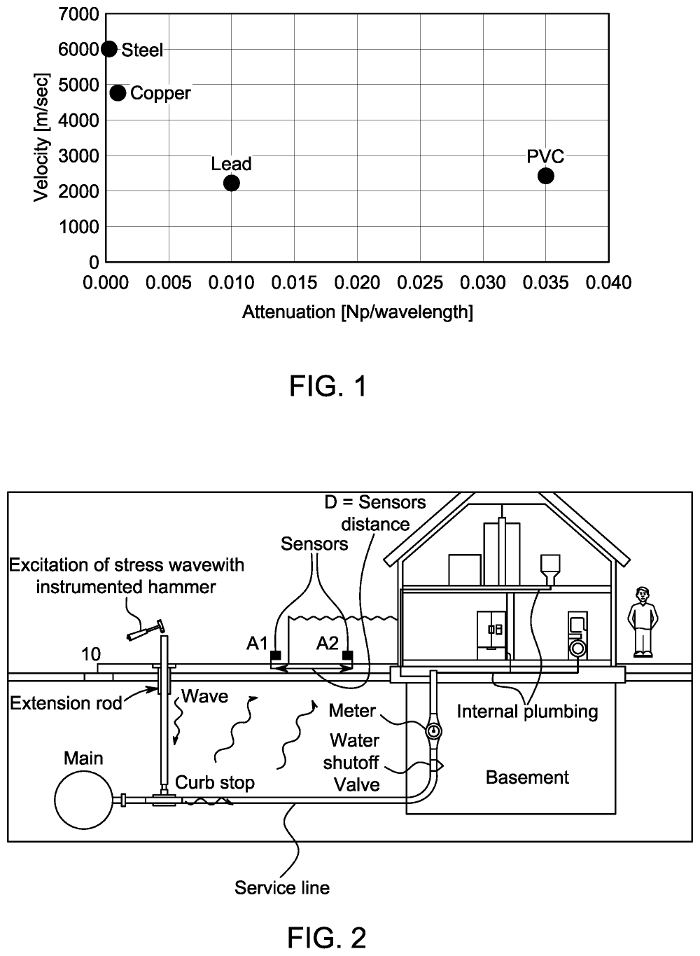

The approach relies on the different speed of propagation and in addition attenuation of waves travelling in pipes of different materials. For instance, as shown in FIG. 1 below, longitudinal waves in lead have a speed of approximately 2,000 m/sec, which is significantly slower than speeds in other metals used for water pipelines (˜6,000 m/sec for steel, ˜5,000 m/sec for copper).

Only plastic has a longitudinal wave speed that is similar to lead. However, stress waves in plastic attenuate significantly more and it is this attenuation that can be used to differentiate lead and plastic in practical applications. Specifically, FIG. 1 shows attenuation of stress waves for different materials along the horizontal axis for different materials. Attenuation is expressed in Np/wavelength (where 1 Np=8.68 decibels) and describes the amplitude decay of a wave travelling one wavelength. FIG. 1 shows how the attenuation of longitudinal stress waves in lead is significantly less than the attenuation in plastic, making it fairly simple to distinguish the 2 materials using a detector. Other metals such as steel and copper have wave attenuations that are even lower, but their speeds also differ from lead and plastic so they are even easier to distinguish.

Summarizing, stress waves in steel and copper propagate much faster than in lead and plastic. In addition, the biggest distinction between lead and plastic is the attenuation, that is much higher in plastic where wave energy will dissipate faster allowing to distinguish the two different materials.

### RESULTS IN THE LABORATORY

The inventors performed preliminary testing on pipelines of different materials embedded in soil. Their laboratory set-up included an oval 4 ft3 LDPE plastic with two holes that were drilled therein along the longitudinal axis of the oval for insertion of a length of pipe. The inserted pipe was buried by 8 in of a uniform layer of compacted fine sand. Sensing probes were placed at three locations along the line of the pipe.

A test was conducted by striking the exposed end of the pipe with an instrumented mini-hammer and recording data at few probe locations. The waveforms recorded by the probes through a dedicated high-speed data logger were used to estimate the time of arrival of the waves at the different probes. Knowing the distance between the probes and after estimating the difference in time of arrival at each probe, the wave speed can be estimated. As expected, the speed was close to 2,000 m/sec in Lead (Pb). In Steel, the wave speed was estimated to be near 6,000 m/sec and in Copper was computed as 5,200 m/sec. In PVC, while the wave has a speed comparable to the one of lead, the wave decayed significantly faster, due to higher attenuation of the material. In summary, this approach was shown to distinguish pipes of different materials and most helpfully the difference between lead and plastic, and has the clear potential to be scalable in real field applications to discover underground lead pipelines.

### PRELIMINARY RESULTS IN THE FIELD

The inventors then performed a field test to observe how the approach could be adopted in practice. The schematic representation of a typical field test is presented in FIG. 2.

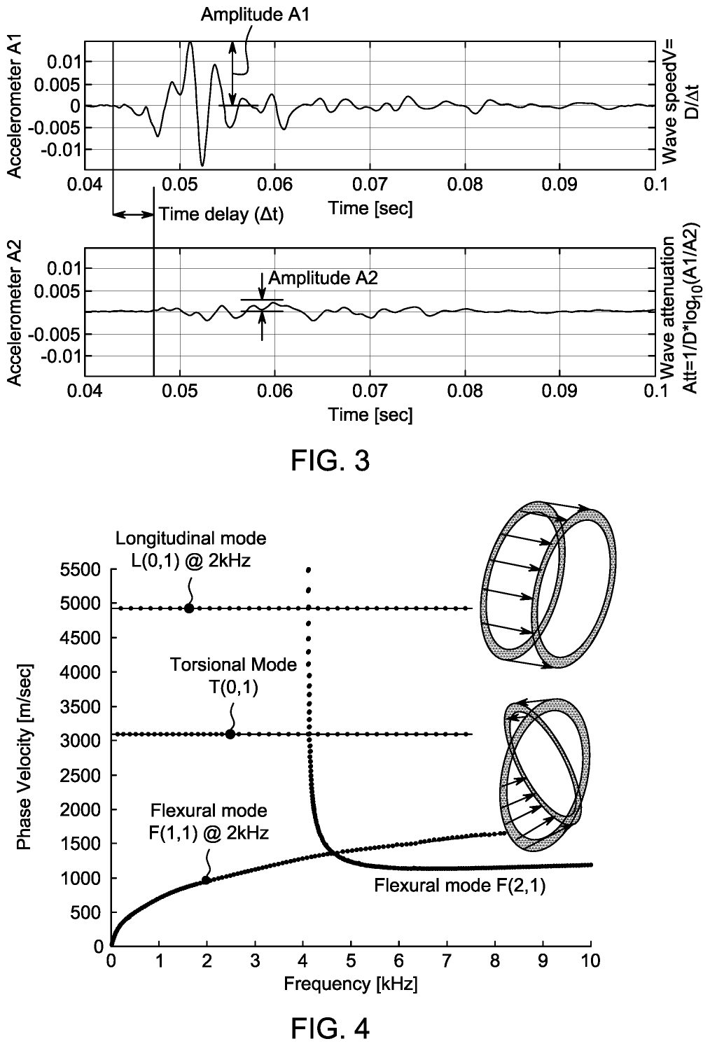

As shown in FIG. 2, the service line is buried underground. An extension rod is used to reach the curb stop, where there is a connection between public and private service line. The curb stop is the only component that can be “excited” with an impact excitation that can be obtained with an instrumented hammer at the top of the extension rod. After the impact, a wave is generated and propagates along the extension rod, then in the service line and finally leaks energy into the soil. The sensors A1 and A2 placed on the surface above the service line (and separated by a distance D) record the oscillations caused by the leaked waves. Time histories recorded by a pair of sensors (A1 and A2) during a field test are shown in FIG. 3 (case of Lead pipeline).

The signals were recorded in the field using 2 sensors, A1 and A2, separated by a distance D=6 feet. The comparison between the signals shows the different arrivals of the waves at A1 and A2. The wave time delay Δt is used to estimate the wave speed in the pipe (in this case a Lead service line) as D/Δt. The amplitudes of the signals A1 and A2 recorded by the first and second sensor respectively can then be used to estimate the wave attenuation. For instance, the attenuation per unitary distance can be estimated as Att=1/D*log₁₀(A1/A2).

Once wave speed and attenuation are extracted from the recorded signals, an algorithm based on FIG. 1 can be used to classify the pipe material. Seven pipelines were tested in the field with the proposed approach and preliminary classification results have shown 5 pipelines properly classified (material identified) and 2 pipelines unclassified (>71% accuracy) which is encouraging considering that this was the first field experience.

### Methodology

Additional opportunities provided by the method discussed are given by 1) the different guided wave modes that can be excited in the pipelines, 2) the different instrumentation that can be deployed to generate and detect the waves and 3) the different algorithms that can be adopted to extract properties of the waves and ultimately identify the material/materials of the pipeline being investigated.

### —Stress Wave Properties

Many types of waves can be generated in a component and their properties may be used for defect detection or to identify the physical properties of the material (density, stiffness, etc.). When stress waves travel along a pipe, which is the case of this method, these mechanical waves are often referred to as guided waves. Different guided wave modes exist depending on the frequency of the wave considered. At low frequencies only fundamental modes exist which carry mechanical energy in different ways along the pipe. For instance, the longitudinal fundamental mode carries the mechanical energy along a pipe by causing a motion of the material particles which is primarily longitudinal (parallel to the pipe). This mode tends also to be the faster mode meaning it travels along the pipe in the shortest amount of time.

Another fundamental mode is the flexural mode that tends to be slower than the longitudinal mode and that causes motion that is predominantly perpendicular to the longitudinal direction of the pipe. Another fundamental mode is the torsional mode that causes a torsional deformation of the pipe while travelling along the pipe. This mode has a speed that is constant with frequency (i.e., it is non dispersive unlike the longitudinal and flexural modes that are considered dispersive). FIG. 4 shows the speed of propagation of the 3 fundamental modes, L (0,1), F (1,1) and T (0,1) and clearly highlights how their speed are different and can vary with the frequency of the wave.

Each of these modes have features that add opportunities to the method presented. At higher frequencies, additional modes are available and can be deployed in the proposed approach. Their extraction from the signals measured during testing can help to properly identify the material properties of a buried pipe and can also support the assessment of the pipe conditions (existence of defects).

### —Excitation and Detection of Stress Waves Properties

The generation and extraction of the stress waves features can be accomplished with a proper combination of excitation, sensing and signal processing. To generate stress waves, different approaches can be used. An impact excitation is the strategy previously mentioned where an instrumented impact hammer is adopted to strike the top of the extension rod connected to the curb stop. Impacts can be imposed in different directions and with different hammers/hammer tips. The direction of the impact can cause the excitation of different modes (longitudinal, flexural, torsional and a combination of them). The excitation can be imposed in other locations (for instance at the meter or inside the house basement or at any other locations where an element of the water infrastructure can be reached). Other impactors can be placed such as small shakers, piezoelectric elements, Electro-Magnetic Acoustic Transducers, laser or air coupled excitations. Passive approaches (where only the waves caused by the ambient vibrations are used) can also provide sufficient energy to extract signals of sufficient strength to be recorded by sensors. In this last scenario, dedicated signal processing strategies need to be adopted to extract the stress waves properties of waves generated in the buried pipes.

The detection of stress waves can be obtained by an array of sensors placed on the surface directly above the pipeline being investigated. The number and configuration of the sensors depend on the specific application. A minimum of 2 sensors is recommended if there is no triggering mechanism used in the data collection. If an instrumented hammer is used to generate and trigger data collection, one sensor is theoretically sufficient but 2 or more sensors are desirable.

The placement of the sensors impacts the proper adoption of the method. Ideally, they should be placed along the surface projection of the pipeline and if that is unknown, a matrix or 2-dimensional array of sensors should be used.

The sensors should have sufficient sensitivity to guarantee a clean signal (sufficient signal to noise ratio) to extract wave propagation properties of interest such as wave speed, wave attenuation, etc.

Accelerometers are common sensors used but any sensor able to accurately capture the wave propagation occurring in the buried pipe represents an adequate sensing strategy. The signals recorded by the sensors are stored in a data acquisition system and then analyzed.

### —Signal Processing

The processing of the signals recorded by the data acquisition system may be done to extract critical properties such as wave speed and attenuation.

Computing the wave speed can occur through basic algorithms that first identify a wave arrival at each sensor location based on the signal amplitude exceeding a pre-established threshold. Dividing the physical distance between the sensors by the difference in time of arrival provides an estimate of the speed.

Time of arrival can be extracted also by more sophisticated approaches by using algorithms based on frequency analysis (Fourier Transform, Wavelet Transform, etc.). An example is the use of the phase of the signals (obtained from the signal Fourier Transform) to estimate the wave speed. Other approaches are based on the cross-correlation algorithm that can be adopted also when there is no direct wave excitation. In this last scenario, a passive approach is adopted by taking advantage of ambient vibrations that are recorded by an array of sensors. In this last scenario, the cross-correlation algorithm is typically used on multiple recordings in combination with averaging to eventually extract the Green's function between the sensors locations which is the response caused by an impulsive excitation. Such response can then be analyzed to identify the material of the inspected pipeline.

In addition, the use of machine learning (ML) and artificial intelligence (AI) methods such as but not limited to decision trees, nearest neighbors, shallow and deep neural networks can be used on the raw signals obtained from a single sensor or sensor arrays to classify the pipe material. Specific features of the signal need not be extracted beforehand to allow these methods to classify, however feature extraction (e.g., entropy, peak spacing, etc.) can improve the accuracy of the methods. Both raw data and feature extracted signals will be evaluated when using ML and AI techniques.

### —Classification

Once data is collected from testing of a buried pipeline, the identification of the material/materials composing the line is performed with possible results shown in Table 1.

TABLE 1

| | | Inferred Composition from Testing | | |
|---|---|---|---|---|
| | | Lead | Non-Lead | Indeterminate |
| True pipe | Lead | True | False | |
| composition | | Positive | Negative | |
| | | (TP) | (FN) | |
| | Non-Lead | False | True | |
| | | Positive | Negative | |
| | | (FP) | (TN) | |

Information extracted from field testing (wave speed of one or multiple wave modes, attenuation) may be leveraged to identify the material of the pipe. If a pipe is composed of Lead, the detection approach is successful if it flags the unknown pipe as a lead pipe (True Positive, TP). A True negative scenario occurs when the proposed detection approach correctly establishes that the pipe is a non-lead pipe. Unwanted scenarios happen when the proposed method identifies a non-lead pipe as a lead Pipe (False positive, FP) or the opposite case occurs (False Negative, FN).

Different classification strategies exist as the ones based on machine learning approaches.

### —Practical Application

The method above, using hardware/software discussed, may be used to identify pipe material, and especially identify material using both propagation and attenuation data, it being the later attenuation data that provides a valuable reference when distinguishing between lead and plastic.

### EMBODIMENTS

Embodiment 1. A nondestructive evaluation method for determining a material used in a below ground service line comprising:
inserting a probe with a wave measurement device therein into an area corresponding to a location of a service line;
generating a wave in the service line through an exposed portion of the service line using a vibratory shaker or other wave generation device;
detecting, by the wave measurement device, at least two substrate waves
created by the service line wave passing through the service line and into a substrate;
identifying, by a data acquisition system, a velocity and an attenuation of the service line wave using the detected at least two substrate waves;
comparing the velocity and attenuation of the service line wave to a known set of wave velocities and attenuations corresponding to different service line materials; and
identifying a service line material in the service line by comparing the velocity and attenuation of the service line wave with the known set of wave velocities and attenuations corresponding to different service line materials.

Embodiment 2. The nondestructive evaluation method of embodiment 1, wherein the detecting is done using more than one probe.

Embodiment 3. The nondestructive evaluation method of embodiment 2, wherein at least two probes are spaced at a distance from one another.

Embodiment 4. The nondestructive evaluation method of embodiment 3, wherein a first probe and a second probe of the probes detect the substrate wave at different times.

Embodiment 5. The nondestructive evaluation method of embodiment 2, wherein the wave measurement devices comprise accelerometers.

Embodiment 6. The nondestructive evaluation method of embodiment 5, wherein the accelerometers are located within a protective sheath.

Embodiment 7. The nondestructive evaluation method of embodiment 1, wherein the generation of a service line wave is done using a vibratory shaker attached to the service line.

Embodiment 8. The nondestructive evaluation method of embodiment 1, wherein the service line wave has a frequency of between 0.01 kHz to 1,000 kHz and above.

Embodiment 9. The nondestructive evaluation method of embodiment 1, wherein an amplitude of the service line is adjusted.

Embodiment 10. A nondestructive evaluation apparatus for determining a material used in a below ground service line comprising:
a probe with a wave measurement device therein, wherein each probe is configured for insertion into an area corresponding to a location of a service line;
a vibratory shaker or impact hammer that generates a service line wave through an exposed portion of the service line;
a wave measurement device that detects at least two substrate waves created by the service line wave passing through the service line and into a substrate;
a data acquisition system that identifies a velocity and attenuation of the service line wave using the detected at least two substrate waves; and
a processor that compares the velocity and attenuation of the service line wave to a known set of wave velocities and attenuations corresponding to different service line materials and identifies a service line material in the service line by comparing the velocity and attenuations of the service line wave with the known set of wave velocities and attenuations corresponding to different service line materials.

Embodiment 11. The nondestructive evaluation apparatus of embodiment 11, further comprising more than one probe.

Embodiment 12. The nondestructive evaluation apparatus of embodiment 12, wherein at least two probes are spaced at a distance from one another.

Embodiment 13. The nondestructive evaluation apparatus of embodiment 13, wherein a first probe and a second probe of the probes detect the substrate wave at different times.

Embodiment 14. The nondestructive evaluation apparatus of embodiment 11, wherein the wave measurement device is an accelerometer.

Embodiment 15. The nondestructive evaluation apparatus of embodiment 15, wherein the probe comprises a cavity in which the accelerometer is located.

Embodiment 16. The nondestructive evaluation apparatus of embodiment 11, wherein the probe comprises a hardened tip.

Embodiment 17. The nondestructive evaluation apparatus of embodiment 11, wherein the service line wave has a frequency of between 0.01 kHz to 1,000 kHz and higher.

Embodiment 18. The nondestructive evaluation apparatus of embodiment 11, wherein the vibratory shaker adjusts an amplitude of the service line wave.

While the invention has been described with reference to the embodiments above, a person of ordinary skill in the art would understand that various changes or modifications may be made thereto without departing from the scope of the claims.

1. A nondestructive evaluation method for determining a material used in a below ground service line comprising:
inserting a probe with a wave measurement device therein into an area corresponding to a location of a service line;
generating a wave in the service line through an exposed portion of the service line using a vibratory shaker or other wave generation device;
detecting, by the wave measurement device, at least two substrate waves created by the service line wave passing through the service line and into a substrate;
identifying, by a data acquisition system, a velocity and an attenuation of the service line wave using the detected at least two substrate waves;
comparing the velocity and attenuation of the service line wave to a known set of wave velocities and attenuations corresponding to different service line materials; and
identifying a service line material in the service line by comparing the velocity and attenuation of the service line wave with the known set of wave velocities and attenuations corresponding to different service line materials.

2. The nondestructive evaluation method of claim 1, wherein the detecting is done using more than one probe.

3. The nondestructive evaluation method of claim 2, wherein at least two probes are spaced at a distance from one another.

4. The nondestructive evaluation method of claim 3, wherein a first probe and a second probe of the probes detect the substrate wave at different times.

5. The nondestructive evaluation method of claim 2, wherein the wave measurement devices comprise accelerometers.

6. The nondestructive evaluation method of claim 5, wherein the accelerometers are located within a protective sheath.

7. The nondestructive evaluation method of claim 1, wherein the generation of a service line wave is done using a vibratory shaker attached to the service line.

8. The nondestructive evaluation method of claim 1, wherein the service line wave has a frequency of between 0.01 kHz to 1,000 kHz and above.

9. The nondestructive evaluation method of claim 1, wherein an amplitude of the service line is adjusted.

10. A nondestructive evaluation apparatus for determining a material used in a below ground service line comprising:
a probe with a wave measurement device therein, wherein each probe is configured for insertion into an area corresponding to a location of a service line;
a vibratory shaker or impact hammer that generates a service line wave through an exposed portion of the service line;
a wave measurement device that detects at least two substrate waves created by the service line wave passing through the service line and into a substrate;
a data acquisition system that identifies a velocity and attenuation of the service line wave using the detected at least two substrate waves; and
a processor that compares the velocity and attenuation of the service line wave to a known set of wave velocities and attenuations corresponding to different service line materials and identifies a service line material in the service line by comparing the velocity and attenuations of the service line wave with the known set of wave velocities and attenuations corresponding to different service line materials.

11. The nondestructive evaluation apparatus of claim 10, further comprising more than one probe.

12. The nondestructive evaluation apparatus of claim 11, wherein at least two probes are spaced at a distance from one another.

13. The nondestructive evaluation apparatus of claim 12, wherein a first probe and a second probe of the probes detect the substrate wave at different times.

14. The nondestructive evaluation apparatus of claim 10, wherein the wave measurement device is an accelerometer.

15. The nondestructive evaluation apparatus of claim 14, wherein the probe comprises a cavity in which the accelerometer is located.

16. The nondestructive evaluation apparatus of claim 10, wherein the probe comprises a hardened tip.

17. The nondestructive evaluation apparatus of claim 10, wherein the service line wave has a frequency of between 0.01 kHz to 1,000 kHz and higher.

18. The nondestructive evaluation apparatus of claim 10, wherein the vibratory shaker adjusts an amplitude of the service line wave.
